(19) United States
(12) Patent Application Publication
(10) Pub. No.: US 2020/0020337 A1
(43) Pub. Date: Jan. 16, 2020

(54) INTELLIGENT VOICE RECOGNIZING METHOD, APPARATUS, AND INTELLIGENT COMPUTING DEVICE

(71) Applicant: LG ELECTRONICS INC., Seoul (KR)

(72) Inventors: Junmin LEE, Seoul (KR); Inho LEE, Seoul (KR); Hansuk SHIM, Seoul (KR); Joonyup LEE, Seoul (KR)

(73) Assignee: LG ELECTRONICS INC., Seoul (KR)

(21) Appl. No.: 16/577,846

(22) Filed: Sep. 20, 2019

(30) Foreign Application Priority Data
Aug. 30, 2019 (KR) 10-2019-0107792

(51) Int. Cl. G10L 15/22; G06F 3/01; G10L 15/08; G06K 9/00

(52) U.S. Cl. CPC G10L 15/22; G06F 3/013; G06F 3/017; G10L 2015/088; G06K 9/00302; G10L 2015/223; G10L 15/08

(57) ABSTRACT

An intelligent voice recognizing method and apparatus are disclosed. The voice recognizing apparatus obtains a first microphone detection signal in wake-up recognition mode, switches to continuous word recognition mode upon recognizing a wake-up word from the first microphone detection signal, obtains a second microphone detection signal, performs a function corresponding to a continuous word upon recognizing the continuous word from the second microphone detection signal, and switches to the continuous word recognition mode upon detecting a preset first gesture. This allows a user to activate the voice recognizing apparatus by saying as few wake-up words as possible, thereby providing convenience to the user. One or more between a voice recognizing apparatus and intelligent computing device according to the present disclosure may be associated with an artificial intelligence module, an unmanned aerial vehicle (UAV), an augmented reality (AR) device, a virtual reality (VR) device, a 5G service-related device, etc.

### CROSS-REFERENCE TO RELATED APPLICATION(S)

This application is based on and claims priority under 35 U.S.C. 119 to Korean Patent Application No. 10-2019-0107792, filed on Aug. 30, 2019, in the Korean Intellectual Property Office, the disclosure of which is herein incorporated by reference in its entirety.

### BACKGROUND OF THE INVENTION

### Field of the invention

The present disclosure relates to an intelligent voice recognizing method and apparatus and an intelligent computing device, more particularly, to an intelligent voice recognizing method and apparatus and an intelligent computing device that can minimize the need to say wake-up words.

### Related Art

A voice recognizing apparatus is an apparatus that converts a user's voice into text, analyzes the meaning of a message contained in the text, and produces other forms of audio based on the result of analysis.

Examples of the voice recognizing system may include home robots in home IoT systems and artificial intelligence (AI) speakers equipped with AI technology.

### SUMMARY OF THE INVENTION

An object of the present disclosure is to meet the needs and solve the problems.

Another aspect of the present disclosure is to provide an intelligent voice recognizing method and apparatus and an intelligent computing device that can minimize the need to say wake-up words to activate the voice recognizing apparatus by using user-related image information and voice information.

An exemplary embodiment of the present disclosure provides a method for a voice recognizing apparatus to intelligently recognize voice, the method comprising: obtaining a first microphone detection signal in wake-up recognition mode; switching to continuous word recognition mode upon recognizing a wake-up word from the first microphone detection signal; obtaining a second microphone detection signal; and performing a function corresponding to a continuous word upon recognizing the continuous word from the second microphone detection signal, wherein the switching to the continuous word recognition mode comprises switching to the continuous word recognition mode upon detecting a preset first gesture.

The method may further comprise: switching to the wake-up word recognition mode after performing a function corresponding to the continuous word; and switching to the continuous word recognition mode upon recognizing a speaker's utterance of the continuous word after switching to the wake-up word recognition mode.

The first gesture may comprise a user's gesture of gazing at the voice recognizing apparatus for a preset amount of time,

The first gesture may comprise a user's gesture of waving a hand toward the voice recognizing apparatus.

The method may further comprise: switching to the wake-up word recognition mode after performing a function corresponding to the continuous word; and switching to the continuous word recognition mode upon detecting a preset second gesture after switching to the wake-up word recognition mode.

The second gesture may comprise a user's gesture of giving a particular expression.

The second gesture may comprise the first gesture.

The second gesture may comprise the user's gesture of gazing at the voice recognizing apparatus for a preset amount of time.

The second gesture may comprise the user's gesture of invoking the voice recognizing apparatus.

The continuous word recognition mode may be maintained while the user is located within a preset distance from the voice recognizing apparatus.

Another exemplary embodiment of the present disclosure provides an intelligent voice recognizing apparatus comprising: at least one microphone; a camera; and a processor, wherein the processor obtains a first microphone detection signal in wake-up recognition mode, switches to continuous word recognition mode upon recognizing a wake-up word from the first microphone detection signal, obtains a second microphone detection signal, and performs a function corresponding to a continuous word upon recognizing the continuous word from the second microphone detection signal, wherein the processor switches to the continuous word recognition mode upon detecting a preset first gesture.

The processor may switch to the wake-up word recognition mode after performing a function corresponding to the continuous word, and switch to the continuous word recognition mode upon recognizing a speaker's utterance of the continuous word after switching to the wake-up word recognition mode.

The first gesture may comprise a user's gesture of gazing at the voice recognizing apparatus for a preset amount of time,

The first gesture may comprise a user's gesture of waving a hand toward the voice recognizing apparatus.

The processor may switch to the wake-up word recognition mode after performing a function corresponding to the continuous word, and switch to the continuous word recognition mode upon detecting a preset second gesture after switching to the wake-up word recognition mode.

The second gesture may comprise a user's gesture of giving a particular expression.

The second gesture may comprise the first gesture.

The second gesture may comprise the user's gesture of gazing at the voice recognizing apparatus for a preset amount of time.

The second gesture may comprise the user's gesture of invoking the voice recognizing apparatus.

The continuous word recognition mode may be maintained while the user is located within a preset distance from the voice recognizing apparatus.

A still another exemplary embodiment of the present disclosure provides a non-transitory, computer-readable recording medium storing a computer-executable component configured to be executed by one or more processors of a computing device, wherein the computer-executable component obtains a first microphone detection signal in wake-up recognition mode, switches to continuous word recognition mode upon recognizing a wake-up word from the first microphone detection signal, obtains a second microphone detection signal, and performs a function corresponding to a continuous word upon recognizing the continuous word from the second microphone detection signal, wherein the computer-executable component switches to the continuous word recognition mode upon detecting a preset first gesture.

An intelligent voice recognizing method and apparatus and an intelligent computing device according to an exemplary embodiment of the present disclosure have the following advantageous effects.

The present disclosure has the advantage of providing convenience to a user because the user is able to activate the voice recognizing apparatus by saying as few wake-up words as possible.

Another advantage of the present disclosure is to give commands to the voice recognizing apparatus even if the user does not know a preset wake-up word for the voice recognizing apparatus.

It is to be understood that the advantages that can be obtained by the present disclosure are not limited to the aforementioned advantages and other advantages which are not mentioned will be apparent from the following description to the person with an ordinary skill in the art to which the present disclosure pertains.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 illustrates a schematic block diagram of a system for implementing a voice recognizing method according to an exemplary embodiment of the present disclosure is implemented.

FIG. 5 is a block diagram of an AI device applicable to exemplary embodiments of the present disclosure.

FIG. 6 is an exemplary block diagram of a voice recognizing apparatus according to an exemplary embodiment of the present disclosure.

FIG. 7 shows a schematic block diagram of a voice recognizing apparatus in a voice recognizing system environment according to an exemplary embodiment of the present disclosure.

FIG. 8 shows a schematic block diagram of a voice recognizing apparatus in a voice recognizing system environment according to another exemplary embodiment of the present disclosure.

FIG. 9 shows a schematic block diagram of an artificial intelligence processor capable of implementing voice recognizing according to an exemplary embodiment of the present disclosure.

FIG. 10 is a flowchart showing a voice recognizing method according to an exemplary embodiment of the present disclosure.

FIG. 11 shows a first example of transition to continuous word recognition mode according to an exemplary embodiment of the present disclosure.

FIG. 12 shows a second example of transition to continuous word recognition mode according to an exemplary embodiment of the present disclosure.

FIG. 13 shows a third example of transition to continuous word recognition mode according to an exemplary embodiment of the present disclosure.

FIG. 14 is a flowchart showing a voice recognizing method according to another exemplary embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

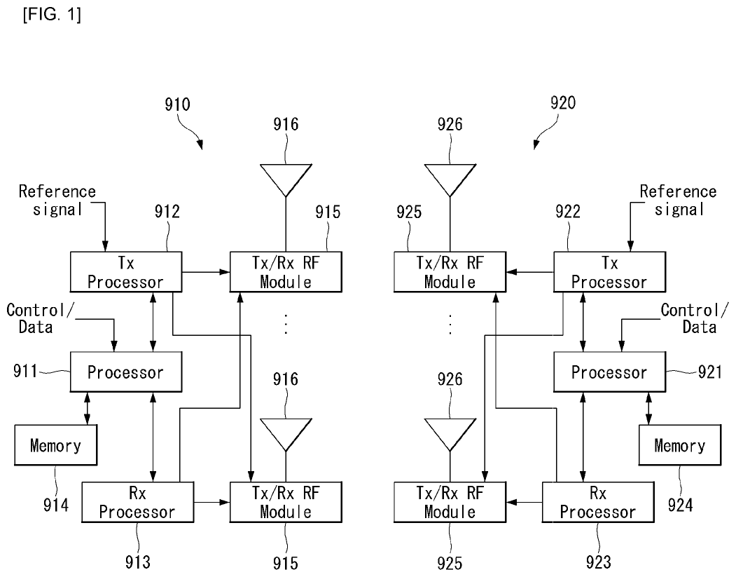

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device(AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal transmission/reception method in wireless communication system

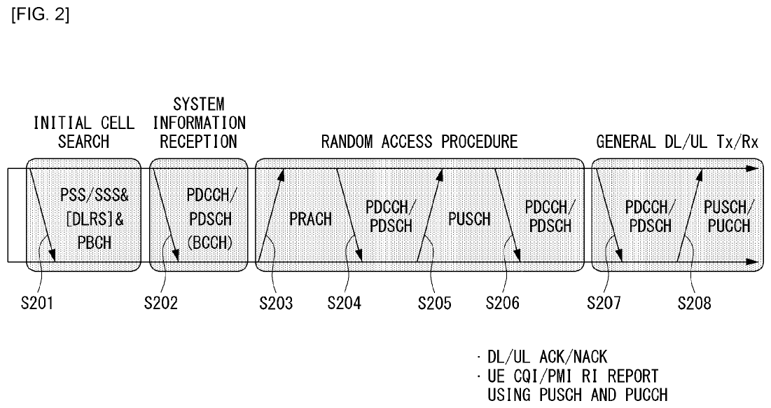

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtained through an SSS of the cell, and information on the cell ID among 336 cell ID groups is provided/obtained through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a

PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

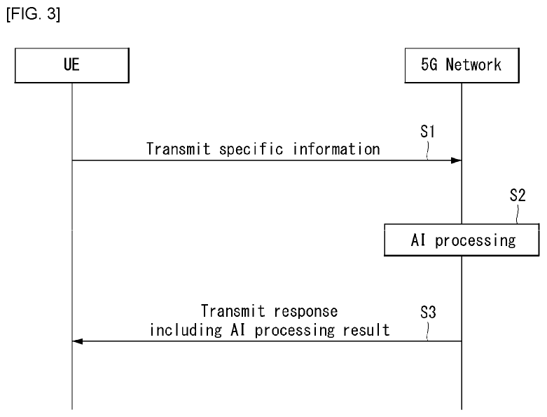

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

H. Voice Recognizing System and AI Processing

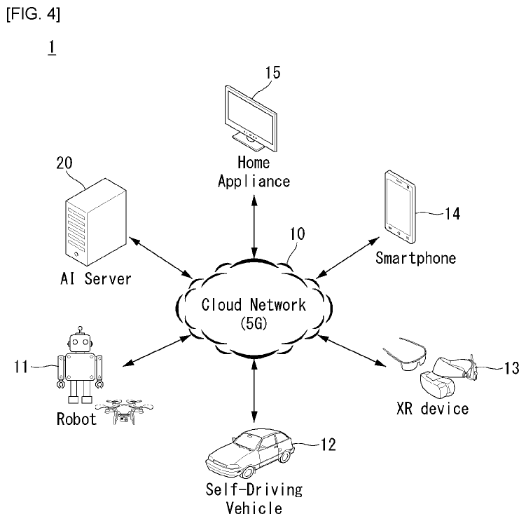

FIG. 4 illustrates a schematic block diagram of a system for implementing a voice recognizing method according to an exemplary embodiment of the present disclosure is implemented.

Referring to FIG. 4, the system for implementing the voice recognizing method according to the exemplary embodiment of the present disclosure is implemented may comprise at least one voice recognizing apparatus 10, a network system 16, and a text-to-speech (TTS) system 18 as a speech synthesis engine.

The at least one voice recognizing apparatus 10 may comprise a mobile phone 11, a PC 12, a laptop computer 13, and other server devices 14. The PC 12 and laptop computer 13 may be connected to at least one network system 16 through a wireless access point 15. According to the exemplary embodiment of the present disclosure, the voice recognizing apparatus 10 may comprise an audiobook, a smart speaker, etc.

Meanwhile, the TTS system 18 may be implemented on a server included in a network or may be implemented through on-device processing and embedded in the voice recognizing apparatus 10. The exemplary embodiment of the present disclosure will be described based on the assumption that the TTS system 18 is embedded and implemented in the voice recognizing apparatus 10.

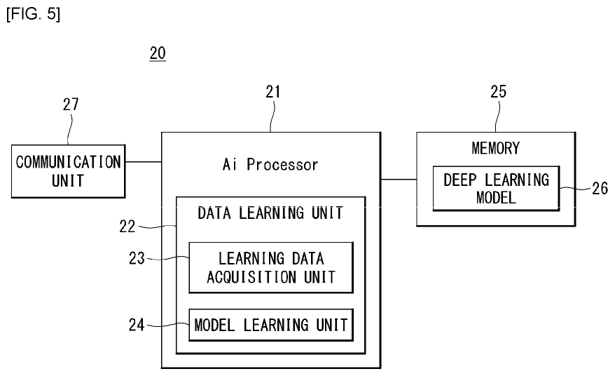

FIG. 5 is a block diagram of an AI device applicable to exemplary embodiments of the present disclosure.

The AI device 20 may comprise an electronic device including an AI module for performing AI processing or a server including the AI module. Also, the AI device 20 may be included as at least some component of the voice recognizing apparatus 10 shown in FIG. 4 so as to perform at least part of the AI processing together with the voice recognizing apparatus 10.

The AI processing may comprise all operations related to the voice recognizing of the voice recognizing apparatus 10 shown in FIG. 5. For example, the AI processing may be a process for recognizing new data by analyzing data acquired through an input part of the voice recognizing apparatus 10.

The AI device 20 may comprise an AI processor 21, a memory 25, and/or a communication part 27.

The AI device 20 is a computing device capable of training a neural network, and may be implemented as various electronic devices such as a server, desktop PC, laptop PC, and tablet PC.

The AI processor 21 may train a neural network by using a program stored in the memory 25.

Particularly, the AI processor 21 may train a neural network for recognizing new data by analyzing data acquired through the input part. Here, the neural network for recognizing data may be designed to emulate a human brain's structure on a computer, and may comprise a plurality of network nodes having weights that emulate neurons in a human neural network.

The plurality of network nodes may send and receive data through connections so that they emulate the synaptic activity of neurons sending and receiving signals through synapses. Such a neural network may comprise a deep learning model, which evolved from a neural network model. In the deep learning model, the plurality of network nodes are arranged in different layers, and may send and receive data through convolutions. Examples of the neural network model include various deep learning techniques such as deep neural networks (DNN), convolutional deep neural networks (CNN), recurrent neural networks (RNN), restricted Boltzmann machines (RBM), deep belief networks (DBN), and deep Q-networks, and are applicable to fields including computer vision, voice recognizing, natural language processing, and voice(speech)/signal processing.

Meanwhile, a processor that performs the above-described functions may be a general-purpose processor (e.g., CPU) or an AI-dedicated processor (e.g., GPU) for artificial intelligence learning.

The memory 25 may store various programs and data required for the operation of the AI device 20. The memory 25 may be implemented as non-volatile memory, volatile memory, flash memory, hard disk drive (HDD), or solid state drive (SSD). The memory 25 is accessed by the AI processor 21, and the AI processor 21 may read, write, modify, delete, or update data. Also, the memory 25 may store a neural network model (e.g., deep learning model 26) created by a learning algorithm for data classification/recognition according to an exemplary embodiment of the present disclosure.

Meanwhile, the AI processor 21 may further comprise a data learning part 22 for training a neural network for data classification/recognition. The data learning part 22 may learn criteria about which learning data it will use to determine on data classification/recognition and how data is classified and recognized using learning data. The data learning part 22 may train a deep learning model by acquiring learning data to be used in learning and applying the acquired learning data to the deep learning model.

The data learning part 22 may be manufactured in the form of at least one hardware chip and mounted on the AI device 20. For example, the data learning part 22 may be manufactured in the form of a hardware chip dedicated to artificial intelligence (AI), or may be manufactured as part of a general-purpose processor (CPU) or dedicated graphics processor (GPU) and mounted on the AI device 20. Also, the data learning part 22 may be implemented as a software module. If it is implemented as a software module (or a program module including instructions), the software module may be stored in a non-transitory computer readable medium. In this case, at least one software module may be provided by an OS (operating system) or by an application.

The data learning part 22 may comprise a learning data acquisition part 23 and a model training part 24.

The learning data acquisition part 23 may acquire learning data required for a neural network model for classifying and recognizing data. For example, the learning data acquisition part 23 may acquire learning data such as data to be fed into the neural network model and/or feature values extracted from data.

By using the acquired learning data, the model training part 24 may train the neural network model to have criteria for determining how to classify certain data. In this instance, the model training part 24 may train the neural network model through supervised learning which uses at least part of the learning data as the criteria for determination. Alternatively, the model training part 24 may train the neural network model through unsupervised learning which helps find criteria for determination by allowing the neural network model to learn on its own without supervision using the learning data. Also, the model training part 24 may train the neural network model through reinforcement learning by using feedback about whether a right decision is made on a situation by learning. Also, the model training part 24 may train the neural network model by using a learning algorithm including error back-propagation or gradient descent.

Once the neural network model is trained, the model training part 24 may store the trained neural network model in memory. The model training part 24 may store the trained neural network model in a memory of a server connected to the AI device 20 over a wired or wireless network.

The data learning part 22 may further comprise a learning data pre-processing part (not shown) and a learning data selection part (not shown), in order to improve analysis results from a recognition model or save the resources or time needed to create the recognition model.

The learning data pre-processing part may pre-process acquired data so that the acquired data is used in learning to recognize new data. For example, the learning data pre-processing part may process acquired learning data into a preset format to enable the model training part 24 to use the acquired data in learning to recognize new data.

Moreover, the learning data selection part may select data required for learning from among the learning data acquired by the learning data acquisition part 23 or the learning data pre-processed by the pre-processing part. The selected learning data may be provided to the model training part 24. For example, the learning data selection part may detect a specific segment from feature values of data acquired by the voice recognizing apparatus 10 so as to select only data about syllables included in the specific segment as learning data.

In addition, the data learning part 22 may further comprise a model evaluation part (not shown) for improving analysis results from the neural network model.

The model evaluation part may feed evaluation data into the neural network model, and, if analysis results produced from the evaluation data do not satisfy a predetermined criterion, may get the model training part 24 to train the neural network model again. In this case, the evaluation data may be data that is defined for evaluating the recognition model. In an example, if the number or proportion of evaluation data from which inaccurate analysis results are produced by analyzing the recognition model trained on the evaluation data exceeds a preset threshold, the model evaluation part may evaluate the analysis results as not satisfying the predetermined criterion.

The communication part 27 may transmit AI processing results from the AI processor 21 to an external electronic device.

Here, the external electronic device may be a voice recognizing apparatus according to an exemplary embodiment of the present disclosure if the AI processor 21 is included in a network system.

Although the AI device 20 shown in FIG. 5 has been described as being functionally divided into the AI processor 21, memory 25, communication part 27, etc., it should be noted that the above-described components may be integrated into one module and called an AI module.

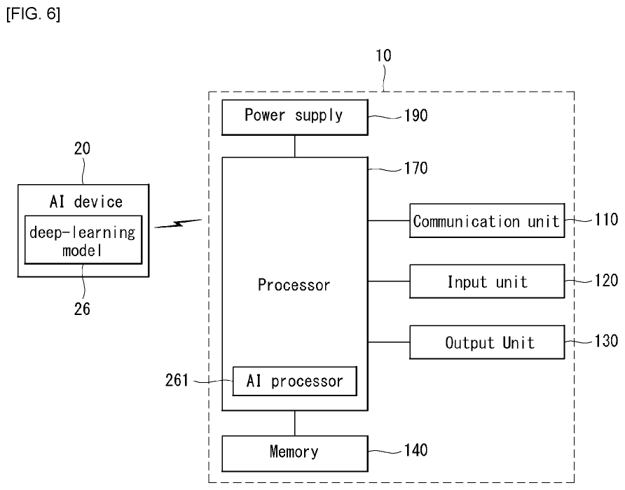

FIG. 6 is an exemplary block diagram of a voice recognizing apparatus according to an exemplary embodiment of the present disclosure.

In the exemplary embodiment of the present disclosure, computer-readable and computer-executable instructions may be included in the voice recognizing apparatus 10. While FIG. 6 discloses a plurality of components included in the voice recognizing apparatus 10, the undisclosed components too may be included in the voice recognizing apparatus 10.

A plurality of voice recognizing apparatuses may be adapted to work as a single voice recognizing apparatus. In such a multi-device system, the voice recognizing apparatus may comprise different components for performing various aspects of voice recognizing and processing. The voice recognizing apparatus 10 shown in FIG. 6 may be an exemplary, independent apparatus, and may be implemented as one component of a larger apparatus or system.

The exemplary embodiment of the present disclosure may be applied to a plurality of different apparatuses and computer systems—for example, a general-purpose computing system, a server-client computing system, a telephone computing system, a laptop computer, a mobile terminal, a PDA, and a tablet computer. The voice recognizing apparatus 10 may be applied as one component of each of different apparatuses or systems that provide voice recognizing, including automated teller machines (ATMs), kiosks, global positioning systems (GPSs), home appliances (e.g., refrigerators, ovens, washing machines, etc.), vehicles, and ebook readers.

As shown in FIG. 6, the voice recognizing apparatus 10 may comprise a communication unit 110, an input unit 120, an output unit 130, a memory 140, a power supply unit 190, and/or a processor 170. Meanwhile, a few of the components disclosed in the voice recognizing apparatus 10 may be the same single component which may repeat itself multiple times in one apparatus.

The voice recognizing apparatus 10 may comprise an address/data bus (not shown) for transmitting data among the components of the voice recognizing apparatus 10. Each of the components in the voice recognizing apparatus 10 may be connected directly to other components via the bus (not shown). Meanwhile, each of the components in the voice recognizing apparatus 1—may be connected directly to the processor 170.

The communication unit 110 may comprise wireless communication equipment such as radio frequency (RF), infrared, Bluetooth, or wireless local area network (WLAN such as Wi-Fi) or wireless networking equipment such as a 5G network, LTE (long term evolution) network, WiMAN network, or 3G network.

The input unit 120 may comprise a microphone, a touch input unit, a keyboard, a mouse, a stylus, or other input unit.

The output unit 130 may output information (e.g., audio) processed by the voice recognizing apparatus 10 or other apparatuses. The output unit 130 may comprise a speaker, a headphone, or other appropriate component that transmits audio. In another example, the output unit 130 may comprise an audio output unit. Also, the output unit 130 may comprise a display (visual display or tactile display), an audio speaker, a headphone, a printer, or other output unit. The output unit 130 may be integrated with the voice recognizing apparatus 10, or may be implemented separately from the voice recognizing apparatus 10.

Also, the input unit 120 and/or the output unit 130 may comprise an interface for connecting external peripherals, such as a universal serial bus (USB), FireWire, Thunderbolt, or other connection protocols. The input unit 120 and/or the output unit 130 may comprise a network connection such as an Ethernet port, modem port, etc. The voice recognizing apparatus 10 may be connected to the internet or a distributed computing environment through the input unit 120 and/or the output unit 130. Also, the voice recognizing apparatus 10 may be connected to a removable or external memory (for example, a removable memory card, memory key drive, network storage, etc.) through the input unit 120 and/or the output unit 130.

The memory 140 may store data and instructions. The memory 140 may comprise magnetic storage, optical storage, solid-state storage, etc. The memory 140 may comprise volatile RAM, non-volatile ROM, or other types of memory.

The voice recognizing apparatus 10 may comprise a processor 170. The processor 170 may be connected to the bus (not shown), input unit 120, output unit 130, and/or other components of the voice recognizing apparatus 10. The processor 170 may correspond to a data processing CPU or a data processing memory for storing computer-readable instructions and data.

Computer instructions to be processed by the processor 170 for running the voice recognizing apparatus 10 and its various components may be executed by the processor 170 or stored in the memory 140, an external device, or a memory or storage included in the processor 170 to be described later. Alternatively, all or some of the executable instructions may be added to software and embedded in hardware or firmware. The exemplary embodiment of the present disclosure may be implemented by, for example, a variety of combinations of software, firmware, and/or hardware.

Specifically, the processor 170 may process textual data into an audio waveform containing voice or process an audio waveform into textual data. Textual data may originate from an internal component of the voice recognizing apparatus 10. Also, the textual data may be received from an input unit such as a keyboard or may be sent to the voice recognizing apparatus 10 via a network connection. Text may take the form of a sentence including text, numbers, and/or punctuation for conversion into voice by the processor 170. Input text may comprise special annotations for processing by the processor 170. The special annotations may indicate how particular text is to be pronounced. The textual data may be processed in real time or may be stored and processed at a later time.

Although not shown in FIG. 6, the processor 170 may comprise a front end, a speech synthesis engine, and TTS storage. The front end may transform input text data into a symbolic linguistic representation for processing by the speech synthesis engine. The speech synthesis engine may transform input text into speech by comparing annotated phonetic unit models and information stored in the TTS storage.

The front end and the speech synthesis engine may comprise an internal embedded processor or memory, or may use the processor 170 or memory 140 included in the voice recognizing apparatus 10. Instructions for running the front end and speech synthesis engine may be included in the processor 170, the memory 140 of the voice recognizing apparatus 10, or an external device.

Text input into the processor 170 may be transmitted to the front end for processing. The front end may comprise a module for performing text normalization, linguistic analysis, and linguistic prosody generation.

During text normalization, the front end processes the text input, generates standard text, and converts numbers, abbreviations, and symbols into the equivalent of written-out words.

During linguistic analysis, the front end may generate a sequence of phonetic units corresponding to the input text by analyzing the language in the normalized text. This process may be called phonetic transcription.

Phonetic units include symbolic representations of sound units to be eventually combined and output by the voice recognizing apparatus 10 as voice(speech). Various sound units may be used for dividing text for the purpose of speech synthesis.

The processor 170 may process speech based on phonemes (individual sounds), half-phonemes, di-phones (the last half of one phoneme coupled with the first half of the adjacent phoneme), bi-phones (two consecutive phonemes), syllables, words, phrases, sentences, or other units. Each word may be mapped to one or more phonetic units. Such mapping may be performed using a language dictionary stored in the voice recognizing apparatus 10.

The linguistic analysis performed by the front end may comprise a process of identifying different grammatical components such as prefixes, suffixes, phrases, punctuation, syntactic boundaries, or the like. Such grammatical components may be used by the processor 170 to craft a natural sounding audio waveform output. The language dictionary may also include letter-to-sound rules and other tools that may be used to pronounce previously unidentified words or letter combinations that may be encountered by the processor 170. Generally, the more the information included in the language dictionary, the higher the quality of speech output.

Based on the linguistic analysis, the front end may then perform linguistic prosody generation where the phonetic units are annotated with desired prosodic characteristics which indicate how the desired phonetic units are to be pronounced in the eventual output speech.

The prosodic characteristics are also called acoustic features. During this stage, the front end may consider and incorporate any prosodic annotations accompanying the text input to the processor 170. Such acoustic features may include pitch, energy, duration, and the like. Application of acoustic features may be based on prosodic models available to the processor 170.

Such prosodic models indicate how specific phonetic units are to be pronounced in certain circumstances. A prosodic model may consider, for example, a phoneme's position in a syllable, a syllable's position in a word, a word's position in a sentence or phrase, neighboring phonetic units, etc. As with the language dictionary, a prosodic model with more information may result in higher quality speech output.

The output of the front end may include a sequence of phonetic units annotated with prosodic characteristics. The output of the front end may be referred to as a symbolic linguistic representation. This symbolic linguistic representation may be sent to the speech synthesis engine.

The speech synthesis engine may perform a process of converting speech into an audio waveform to output it to a user through the output unit 130. The speech synthesis engine may be configured to convert input text into high-quality natural-sounding speech in an efficient manner. Such high-quality speech may be configured to sound as much like a human speaker as possible.

The speech synthesis engine may perform speech synthesis using one or more different methods.

A unit selection engine matches the symbolic linguistic representation created by the front end against a recorded speech database. The unit selection engine matches the symbolic linguistic representation against spoken audio units in the speech database. Matching units are selected and concatenated together to form a speech output. Each unit includes an audio waveform corresponding with a phonetic unit, such as a short .wav file of the specific sound, along with a description of the various acoustic features associated with the .wav file (such as its pitch, energy, etc.), as well as other information, such as where the phonetic unit appears in a word, sentence, or phrase, the neighboring phonetic units, etc.

Using all the information in the unit database, the unit selection engine may match units to the input text to create a natural sounding waveform. The unit database may include multiple examples of phonetic units to provide the voice recognizing apparatus 10 with many different options for concatenating units into speech. One benefit of unit selection is that, depending on the size of the database, a natural sounding speech output may be generated. Moreover, the larger the unit database, the more likely the voice recognizing apparatus 10 will be able to construct natural sounding speech.

Another method of speech synthesis other than the above-described unit selection synthesis includes parametric synthesis. In parametric synthesis, synthesis parameters such as frequency, volume, and noise may be varied by a parametric synthesis engine, a digital signal processor, or other audio generation device to create an artificial speech waveform output.

Parametric synthesis may use an acoustic model and various statistical techniques to match a symbolic linguistic representation with desired output speech parameters. Parametric synthesis allows for processing of speech without a large-volume database associated with unit selection and also allows for accurate processing of speech at high speeds. Unit selection synthesis and parametric synthesis may be performed individually or combined together to produce speech audio output.

Parametric speech synthesis may be performed as follows. The processor 170 may include an acoustic model which may convert a symbolic linguistic representation into a synthetic acoustic waveform of text input based on audio signal manipulation. The acoustic model may include rules which may be used by the parametric synthesis engine to assign specific audio waveform parameters to input phonetic units and/or prosodic annotations. The rules may be used to calculate a score representing a likelihood that a particular audio output parameter(s) (such as frequency, volume, etc.) corresponds to the portion of the input symbolic linguistic representation from the front end.

The parametric synthesis engine may use a number of techniques to match speech to be synthesized with input phonetic units and/or prosodic annotations. One common technique is using Hidden Markov Models (HMMs). HMMs may be used to determine probabilities that audio output should match textual input. HMMs may be used to transition from parameters from the linguistic and acoustic space to the parameters to be used by a vocoder (a digital voice encoder) to artificially synthesize the desired speech.

The voice recognizing apparatus 10 may be configured with a phonetic unit database for use in unit selection. The phonetic unit database may be stored in the memory 140 or other storage component. The phonetic unit database may include recorded speech utterances. The speech utterances may be text corresponding to the utterances. The phonetic unit database may include recorded speech (in the form of audio waveforms, feature vectors, or other formats), which may occupy a significant amount of storage in the voice recognizing apparatus 10. The unit samples in the phonetic unit database may be classified in a variety of ways including by phonetic unit (phoneme, diphone, word, etc.), linguistic prosodic label, acoustic feature sequence, speaker identity, etc. The sample utterances may be used to create mathematical models corresponding to desired audio output for particular phonetic units.

When matching a symbolic linguistic representation, the speech synthesis engine may attempt to select a unit in the phonetic unit database that most closely matches the input text (including both phonetic units and prosodic annotations). Generally, the larger the phonetic unit database, the greater the number of unit samples that can be selected, thereby enabling accurate speech output.

The processor 170 may transmit audio waveforms containing speech output to the output unit 130 to output them to the user. The processor 170 may store the audio waveforms containing speech in the memory 140 in a number of different formats such as a series of feature vectors, uncompressed audio data, or compressed audio data. For example, the processor 170 may encode and/or compress speech output by an encoder/decoder prior to transmission. The encoder/decoder may encode and decode audio data, such as digitized audio data, feature vectors, etc. The functionality of the encoder/decoder may be located in a separate component, or may be executed by the processor 170.

Meanwhile, the memory 149 may store other information for voice recognizing. The content of the memory 140 may be prepared for general voice recognizing or may be customized to include sounds and words that are likely to be used in a particular application. For example, for TTS processing by a global positioning system (GPS), the TTS storage may include customized speech specialized for positioning and navigation.

Also, the memory 140 may be customized for an individual user based on his/her individualized desired speech output. For example, the user may prefer a speech output voice to be a specific gender, have a specific accent, be spoken at a specific speed, or have a distinct emotive quality (e.g., a happy voice). The speech synthesis engine may include specialized databases or models to account for such user preferences.

The voice recognizing apparatus 10 also may be configured to perform TTS processing in multiple languages. For each language, the processor 170 may include specially configured data, instructions, and/or components to synthesize speech in the desired language(s).

To improve performance, the processor 170 may revise/update the content of the memory 140 based on feedback about the results of TTS processing, thus enabling the processor 170 to improve voice recognizing beyond the capabilities provided in the training corpus.

With improvements in the processing capability of the voice recognizing apparatus 10, speech output can be produced by reflecting emotional attributes of input text. Alternatively, the voice recognizing apparatus 10 is capable of speech output by reflecting the user's intent (emotional information) who wrote the input text, even if the input text does not contain emotional attributes.

When building a model to be integrated with a TTS module that actually performs TTS processing, the TTS system may integrate the aforementioned various components and other components. In an example, the voice recognizing apparatus 10 may comprise a block for setting a speaker.

A speaker setting part may set a speaker for each character that appears in a script. The speaker setting part may be integrated with the processor 170 or integrated as part of the front end or speech synthesis engine. The speaker setting part allows text corresponding to multiple characters to be synthesized in a set speaker's voice by using metadata corresponding to the speaker's profile.

According to the exemplary embodiment of the present disclosure, the metadata may be a markup language, preferably, a speech synthesis markup language (SSML).

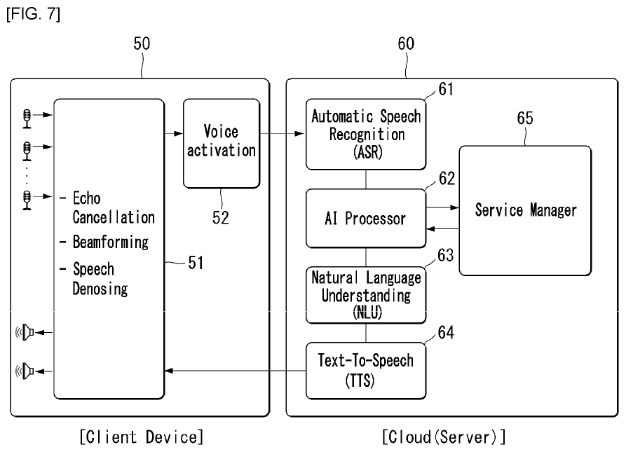

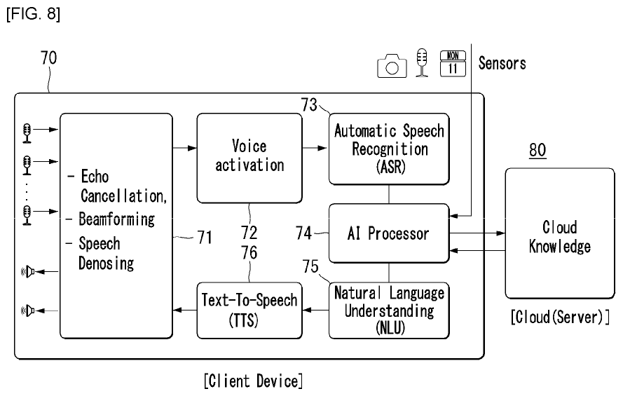

Hereinafter, speech processing processes (voice recognizing and speech output (TTS) process) will be described with reference to FIGS. 7 and 8, which are performed in a device environment and/or cloud environment (or service environment). In FIGS. 7 and 8, the device environment 50 and 70 may be called a client device, and the cloud environment 60 and 80 may be called a server. FIG. 7 illustrates an example in which speech input occurs on the device 50 but the process of processing the input speech to synthesize the speech—i.e., the overall speech processing operation—is performed in the cloud environment 60. On the contrary, FIG. 8 illustrates an example of on-device processing, in which the aforementioned overall speech processing operation is performed on the device 70 to process the input speech to synthesize the speech.

FIG. 7 shows a schematic block diagram of a voice recognizing apparatus in a voice recognizing system environment according to an exemplary embodiment of the present disclosure.

There are many components required to process speech events under an end-to-end speech UI experience. A sequence for processing speech events starts with signal acquisition and playback, followed by speech pre-processing, voice activation, voice recognizing, natural language understanding and finally speech synthesis where the device responds to the user.

The client device 50 may comprise an input module. The input module may receive user input from the user. For example, the input module may receive user input from a connected external device (e.g., a keyboard or headset). Further, the input module may comprise, for example, a touchscreen. Further, the input module may comprise, for example, a hardware key located on a user terminal.

According to the exemplary embodiment, the input module may comprise at least one microphone capable of receiving the user's utterance as a speech signal. The input module may comprise a speech input system, and receive the user's utterance as a speech signal through the speech input system. The at least one microphone may determine a digital input signal for the user's utterance by generating an input signal for audio input. According to the exemplary embodiment, a plurality of microphones may be implemented as an array. The array may be arranged in a geometric pattern, for example, a linear geometric pattern, circular geometric pattern, or any other configuration. For example, a microphone array of four sensors may be placed in a circular pattern relative to a given point, divided by 90 degrees to receive sounds from four directions. In some implementations, the microphones may comprise spatially different sensors in an array in data communication—that is, a networked microphone array. The microphones may comprise omnidirectional microphones, directional microphones (e.g., shotgun microphones), etc.

The client device 50 may comprise a pre-processing module 51 for pre-processing a user input (speech signal) received through the input module (e.g., microphone).

The pre-processing module 51 may include an adaptive echo canceler (AEC) function to remove echoes from the user input (speech signal) received through the microphone. The pre-processing module 51 may include a noise suppression (NS) function to remove background noise from the user input. The pre-processing module 51 may include an end-point detect (EPD) function to detect an end point of the user's speech and find where the user's speech is present. Also, the pre-processing module 51 may include an automatic gain control (ACG) function to adjust the volume of the user input to make the user input suitable for recognition and processing.

The client device 50 may comprise a voice activation module 52. The voice activation module 52 may recognize a wake-up command to recognize what the user is speaking (e.g., a wake-up word). The voice activation module 52 may detect a predetermined keyword (e.g., Hi LG) from the user input that has gone through the pre-processing process. The voice activation module 52 may be on standby and perform an always-on keyword detection function.

The client device 50 may send the user's speech input to a cloud server. Automatic voice recognizing (ASR) and natural language understanding (NLU), which are key components for processing the user's speech, have traditionally run in a cloud due to computing, storage, and power constraints, but are not necessarily limited to it and may run in the client device 50.

The cloud may comprise a cloud device 60 for processing user input sent from a client. The cloud device 60 may be present in the form of a server.

The cloud device 60 may comprise an auto voice recognizing (ASR) module 61, an artificial intelligent agent 62, a natural language understanding (NLU) module 63, a text-to-speech (TTS) module 64, and a service manager 65.

The ASR module 61 may convert the user's speech input received from the client device 50 into text data.

The ASR module 61 may comprise a front-end speech pre-processor. The front-end speech pre-processor extracts representative features from the speech input. For example, the front-end speech pre-processor can perform a Fourier transform on the speech input to extract spectral features that characterize the speech input as a sequence of representative multi-dimensional vectors. Further, the ASR module 61 includes one or more voice recognizing models (e.g., acoustic models and/or language models) and can implement one or more voice recognizing engines. Examples of the voice recognizing models include Hidden Markov models, Gaussian-mixture models, deep neural network models, n-gram language models, and other statistical models. Examples of the voice recognizing engines include dynamic time warping-based engines and weighted finite-state transducer (WFST)-based engines. The one or more voice recognizing models and the one or more voice recognizing engines are used to process the extracted representative features of the front-end speech pre-processor, in order to produce intermediate recognitions results (e.g., phonemes, phonemic strings, and sub-words), and ultimately, voice recognizing results (e.g., words, word strings, or a sequence of tokens).

Once the ASR module 61 produces a recognition result containing a text string (e.g., words, a sequence of words, or a sequence of tokens), the recognition result is passed to the natural language understanding module (NLU) 63 for intent inferencing. In some examples, the ASR module 61 produces multiple candidate text representations of the speech input. Each candidate text representation is a sequence of words or tokens corresponding to the speech input.

The NLU module 63 may grasp the user's intent by performing syntactic analysis or semantic analysis. The syntactic analysis may segment the user input into syntactic units (e.g., words, phrases, morphemes, and the like) and determine which syntactic elements the segmented units have. The semantic analysis may be performed by using semantic matching, rule matching, formula matching, or the like. As such, the NLU module 63 may obtain a domain, an intent, or parameters required for the user input to express the intent.

The NLU module 63 may determine the user's intent and the parameters by using matching rules categorized by domains, intents, and parameters required to grasp the intent. For example, one domain (e.g., an alarm) may include a plurality of intents (e.g., alarm settings, alarm cancellation, and the like), and one intent may include a plurality of parameters (e.g., a time, the number of iterations, an alarm sound, and the like). For example, a plurality of rules may include one or more key element parameters. The matching rule may be stored in a natural language understanding database.

The NLU module 63 may understand the meaning of words extracted from a user input by using linguistic features (e.g., grammatical elements) such as morphemes, phrases, and the like and may match the understood meaning of the words to the domains and intents to determine the user's intent.

For example, the NLU module 63 may calculate how many words extracted from the user input are included in each domain and intent, in order to determine the user's intent. According to the exemplary embodiment, the NLU module 63 may determine parameters for the user input by using the words that are the basis for grasping the intent.

According to the exemplary embodiment, the NLU module 63 may determine the user's intent by using the natural language understanding database storing the linguistic features for grasping the intent of the user input.

According to the exemplary embodiment, the NLU module 63 may determine the user's intent by using a personal language model (PLM). For example, the NLU module 63 may determine the user's intent by using personalized information (e.g., a contact list, music list, schedule information, social network information, etc.).

For example, the personal language model may be stored in the natural language understanding database. According to the exemplary embodiment, the ASR module 61 as well as the NLU module 63 may recognize the user's speech with reference to the personal language model stored in the natural language understanding database.

The NLU module 63 may further comprise a natural language generation module (not shown). The natural language generation module may convert specified information into text form. The information converted into text form may be in the form of a natural language utterance. For example, the specified information may be information about an additional input, information for guiding the completion of an action corresponding to the user input, or information for guiding the additional input of the user. The information converted into text form may be displayed on the display after being transmitted to the client device or may be converted into speech form after being transmitted to the TTS module.

The speech synthesis module (TTS module) 64 may convert text information into speech form. The TTS module 64 may receive text information from the natural language generation module of the NLG module 63, convert the text information into speech form, and transmit it to the client device 50. The client device 50 may output the information in text form through a speaker.

The speech synthesis module 64 synthesizes speech outputs based on text provided. For example, a result generated from the voice recognizing module 61 is in the form of a text string. The speech synthesis module 64 converts the text string to an audible speech output. The speech synthesis module 64 uses any appropriate speech synthesis technique in order to generate speech outputs from text, including, but not limited, to concatenative synthesis, unit selection synthesis, di phone synthesis, domain-specific synthesis, formant synthesis, articulatory synthesis, hidden Markov model (HMM) based synthesis, and sinewave synthesis.

In some examples, the speech synthesis module 64 is configured to synthesize individual words based on phonemic strings corresponding to the words. For example, a phonemic string is associated with a word in the generated text string.

The phonemic string is stored in metadata associated with the word. The speech synthesis module 64 is configured to directly process the phonemic string in the metadata to synthesize the word in speech form.

Because a cloud environment generally has more processing power or resources than a client device, it is possible to obtain higher quality speech outputs than would be practical with client-side synthesis. However, the present disclosure is not limited to this, and actual speech synthesis may occur on the client device (see FIG. 8).

Meanwhile, according to the exemplary embodiment of the present disclosure, an artificial intelligence processor (AI processor) 62 may be further included in a cloud environment. The artificial intelligence processor 62 may be designed to perform at least some of the functions performed by the above-described ASR module 61, NLU module 63, and/or TTS module 64. Also, the artificial intelligence processor 62 may contribute to performing individual functions of the ASR module 61, NLU module 63, and/or TTS module 64.

The artificial intelligence processor 62 may perform the aforementioned functions via deep learning. In the deep learning, a lot of research is being carried out to represent certain data in a computer-readable form (for example, to represent pixel information of an image by a column vector) and apply this to learning (regarding how to prepare better representation techniques and how to create a model for learning them). As results of this effort, deep learning techniques such as deep neural networks (DNN), convolutional deep neural networks (CNN), recurrent neural networks (RNN), restricted Boltzmann machines (RBM), deep belief networks (DBN), and deep Q-networks are applicable to fields including computer vision, voice recognizing, natural language processing, and speech/signal processing.

Currently, all major commercial voice recognizing systems (e.g., Microsoft Cortana, Skype Transistor, Google Now, Apple Siri, etc.) are based on deep learning.

Particularly, the artificial intelligence processor 62 may perform various processes of natural language processing, including machine translation, emotion analysis, and information retrieval, by using a deep artificial neural network architecture in the field of natural language processing.

Meanwhile, the cloud environment may comprise a service manager 65 that gathers various personalized information and supports the functionality of the artificial intelligence processor 62. The personalized information acquired through the service manager may include at least one data set (from the use of a calendar application, messaging service, music application, etc.) the client device 50 uses through the cloud environment, at least one sensor data set (camera, microphone, temperature, humidity, gyro sensor, C-V2X, pulse, ambient light, iris scan, etc.) the client device 50 and/or cloud 60 gathers, and off-device data which is not directly associated with the client device 50. For example, the personalized information may comprise maps, SMS, news, music, stocks, weather, and Wikipedia information.

Although the artificial intelligence processor 62 is represented as a separate block so that it can be distinguished from the ASR module 61, NLU module 63, and TTS module 64 for convenience of explanation, the artificial intelligence processor 62 may perform at least some or all of the functions of each of the modules 61, 63, and 64.

The artificial intelligence processor 62 may perform at least some of the functions of the AI processor 21 and 261 described with reference to FIGS. 5 and 6.

FIG. 8 shows a schematic block diagram of a voice recognizing apparatus in a voice recognizing system environment according to another exemplary embodiment of the present disclosure.

The client device 70 and cloud environment 80 shown in FIG. 8 may correspond to the client device 50 and cloud environment 60 mentioned with reference to FIG. 7, except for the differences in some of their components and functions. Accordingly, specific functions of the corresponding blocks will be described with reference to FIG. 7.

Referring to FIG. 8, the client device 70 may comprise a pre-processing module 71, a voice activation module 72, an ASR module 73, an artificial intelligence processor 74, an NLU module 75, and a TTS module 76. Further, the client device 70 may comprise an input module (at least one microphone) and at least one output module.

Further, the cloud environment 80 may comprise cloud knowledge which store personalized information in the form of knowledge.

The functions of each of the modules shown in FIG. 8 will be described with reference to FIG. 7. However, because the ASR module 73, NLU module 75, and TTS module 76 are included in the client device 70, no communication with the cloud may be needed for speech processing processes such as voice recognizing and speech synthesis, thereby enabling instantaneous and real-time speech processing.

The modules shown in FIGS. 7 and 8 are illustrative only and more or fewer modules than those shown in FIGS. 7 and 8 may be provided. Also, it should be noted that two or more modules may be combined or different modules or different arrays of modules may be provided. The various modules shown in FIGS. 7 and 8 may be implemented by one or more signal processing and/or custom integrated circuits, hardware, software instructions to be executed by one or more processors, firmware, or a combination thereof.

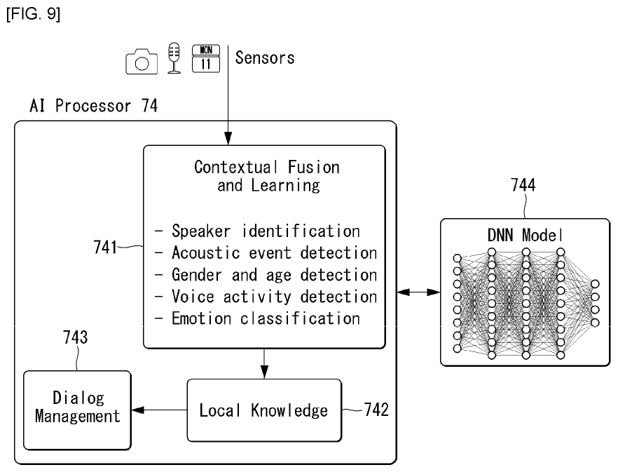

FIG. 9 shows a schematic block diagram of an artificial intelligence processor capable of implementing voice recognizing according to an exemplary embodiment of the present disclosure.

Referring to FIG. 9, the artificial intelligence processor 74 may support interactive operation with the user, aside from performing the ASR operation, NLU operation, and TTS operation in the speech processing processes described with reference to FIGS. 7 and 8. Alternatively, the artificial intelligence processor 74 may contribute to allowing the NLU module 63 of FIG. 7 to perform the operation of making the information contained in text representations received from the ASR module 61 more accurate and supplementing or additionally defining it, by using context information.

Here, the context information may comprise the client device user's preferences, the client device's hardware and/or software conditions, various sensor information gathered before, during, or immediately after user input, and previous interactions (e.g., conversations) between the artificial intelligence processor and the user, and so on. Needless to say, the context information as used herein is dynamic and varies depending on time, location, content of conversations, and other factors.

The artificial intelligence processor 74 may further comprise a contextual fusion and learning module 741, local knowledge 742, and dialog management 743.

The contextual fusion and learning module 741 may learn the user's intent based on at least one data set. The at least one data set may comprise at least one sensing data acquired from a client device or cloud environment. Further, the at least one data set may include speaker identification, acoustic event detection, speaker's personal information (gender and age) detection, voice activity detection (VAD), and emotion classification.

The speaker identification may refer to specifying a speaker by their voice from a set of registered dialogs. The speaker identification may involve a process of identifying a registered speaker or registering a new speaker. The acoustic event detection may recognize the type of a sound and the place where the sound is coming from, by recognizing the sound itself beyond the voice recognizing technology. The voice activity detection (VAD) is a speech processing technique in which the presence or absence of human speech is detected from an audio signal that may include music, noise, or other sounds. According to an example, the artificial intelligence processor 74 may check on the presence of speech from the input audio signal. According to an example, the artificial intelligence processor 74 may distinguish between speech data and non-speech data by using a deep neural network (DNN) model. Also, the artificial intelligence processor 74 may perform emotion classification on speech data by using the deep neural network (DNN) model. By the emotion classification, the speech data may be classified as anger, boredom, fear, happiness, or sadness.

The contextual fusion and learning module 741 may comprise a DNN model for performing the above-described operation, and may grasp the intent of user input based on sensing information gathered from the DNN model and the client device or cloud environment.

The at least one data set is illustrative only and may comprise any data that can be referenced to grasp the user's intent in a speech processing process. Needless to say, the at least one data set may be acquired through the aforementioned DNN model.

The artificial intelligence processor 74 may comprise local knowledge 742. The local knowledge 742 may contain user data. The user data may include the user's preferences, the user address, the user's default language, the user's contact list, and so on. According to an example, the artificial intelligence processor 74 may additionally define the user's intent by supplementing the information contained in the user's speech input by using specific information of the user. For example, in response to a request from the user, saying “Invite my friends to my birthday party”, the artificial intelligence processor 74 may use the local knowledge 742, instead of requiring the user to provide more accurate information to determine who are the “friends” and when and where the “birthday party” will take place.

The artificial intelligence processor 74 may further comprise dialog management 743. The artificial intelligence processor 74 may provide a dialog interface to enable voice conversations with the user. The dialog interface may refer to a process of outputting a response to speech input from the user through a display or speaker. Here, the final output produced through the dialog interface may be based on ASR operation, NLU operation, and TTS operation.

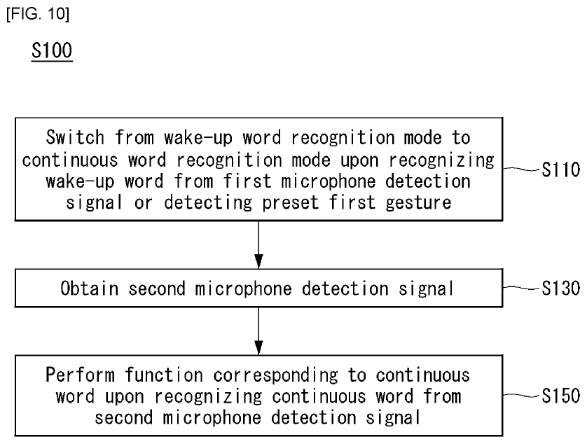

FIG. 10 is a flowchart showing a voice recognizing method according to an exemplary embodiment of the present disclosure.

As shown in FIG. 10, according to the exemplary embodiment of the present disclosure, upon recognizing a wake-up word from a first microphone detection signal or detecting a preset first gesture, the voice recognizing apparatus 10 may switch from wake-up word recognition mode to continuous word recognition mode (S110).

Here, the term “wake-up word recognition mode” may refer to a standby state for recognizing a wake-up word. Here, the term “continuous word recognition mode” may refer to a standby state for recognizing a continuous word (command) from a user after recognizing a wake-up word.

Next, the voice recognizing apparatus may obtain a second microphone detection signal (S130).

Subsequently, upon recognizing a continuous word from the second microphone detection signal, the voice recognizing apparatus may perform a function corresponding to the continuous word (S150).

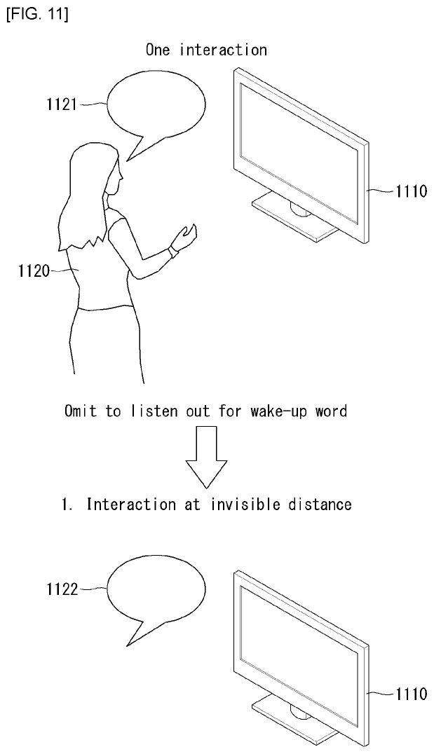

FIG. 11 shows a first example of transition to continuous word recognition mode according to an exemplary embodiment of the present disclosure.

As shown in FIG. 11, a voice recognizing apparatus 1110 may omit to listen out for a wake-up word based on one interaction with a user 1120 and switch to continuous word recognition mode based on an interaction at an invisible distance.

For example, once the voice recognizing apparatus recognizes a wake-up word 1121 from the user, it may omit to listen out for a wake-up word and switch to the continuous word recognition mode based on an interaction at an invisible distance.

For example, upon recognizing the user's gesture of gazing at the voice recognizing apparatus for a preset amount of time or the user's gesture of waving their hand toward the voice recognizing apparatus, the voice recognizing apparatus may omit to listen out for a wake-up word and switch to the continuous word recognition mode based on an interaction at an invisible distance.

For example, the voice recognizing apparatus may omit to listen out for a wake-up word, may capture the user by a camera, and, once the captured user has moved a distance (invisible distance) not captured by the camera, may maintain the continuous word recognition mode through an interaction (e.g., the user's gesture of giving a particular expression, the user's gesture of gazing at the voice recognizing apparatus for a preset amount of time, the user's gesture of waving their hand toward the voice recognizing apparatus, or the user's gesture of invoking the voice recognizing apparatus).

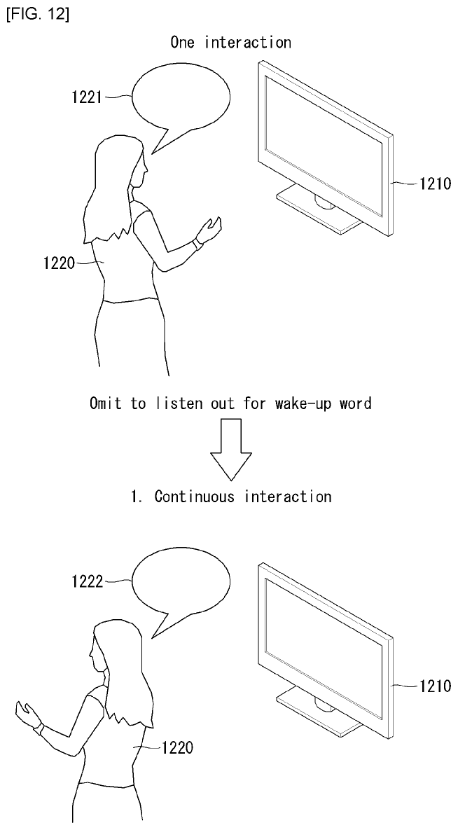

FIG. 12 shows a second example of transition to continuous word recognition mode according to an exemplary embodiment of the present disclosure.

As shown in FIG. 12, a voice recognizing apparatus 1210 may omit to listen out for a wake-up word based on one interaction with a user 1220 and switch to continuous word recognition mode based on an interaction at an invisible distance.

For example, once the voice recognizing apparatus recognizes a wake-up word 1221 from the user, it may omit to listen out for a wake-up word and switch to the continuous word recognition mode based on an interaction at an invisible distance.

For example, upon recognizing the user's gesture of gazing at the voice recognizing apparatus for a preset amount of time or the user's gesture of waving their hand toward the voice recognizing apparatus, the voice recognizing apparatus may omit to listen out for a wake-up word and switch to the continuous word recognition mode based on an interaction at an invisible distance.

For example, the voice recognizing apparatus may omit to listen out for a wake-up word, may capture the user by a camera, and, once the captured user has moved a distance (invisible distance) not captured by the camera, may maintain the continuous word recognition mode through an interaction (e.g., the user's gesture of giving a particular expression, the user's gesture of gazing at the voice recognizing apparatus for a preset amount of time, the user's gesture of waving their hand toward the voice recognizing apparatus, or the user's gesture of invoking the voice recognizing apparatus).

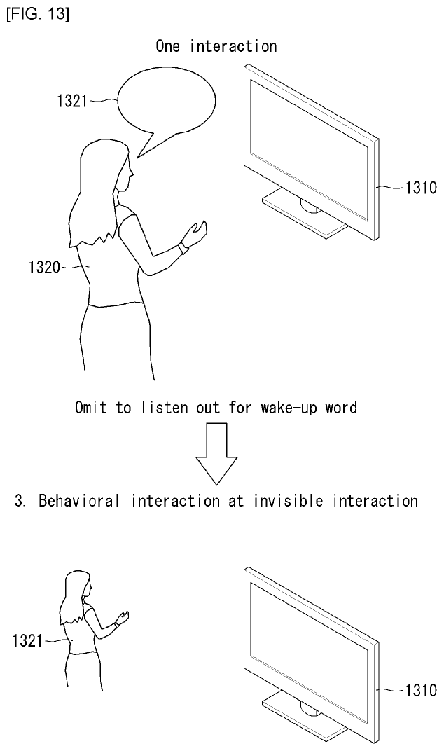

FIG. 13 shows a third example of transition to continuous word recognition mode according to an exemplary embodiment of the present disclosure.

As shown in FIG. 13, a voice recognizing apparatus 1310 may omit to listen out for a wake-up word based on one interaction with a user 1320 and switch to continuous word recognition mode based on an interaction at an invisible distance.

For example, once the voice recognizing apparatus recognizes a wake-up word 1321 from the user, it may omit to listen out for a wake-up word and switch to the continuous word recognition mode based on an interaction at an invisible distance.

For example, upon recognizing the user's gesture of gazing at the voice recognizing apparatus for a preset amount of time or the user's gesture of waving their hand toward the voice recognizing apparatus, the voice recognizing apparatus may omit to listen out for a wake-up word and switch to the continuous word recognition mode based on an interaction at an invisible distance.

For example, the voice recognizing apparatus may omit to listen out for a wake-up word, may capture the user by a camera, and, once the captured user has moved a distance (invisible distance) not captured by the camera, may maintain continuous word recognition mode through an interaction (e.g., the user's gesture of giving a particular expression, the user's gesture of gazing at the voice recognizing apparatus for a preset amount of time, the user's gesture of waving their hand toward the voice recognizing apparatus, or the user's gesture of invoking the voice recognizing apparatus).

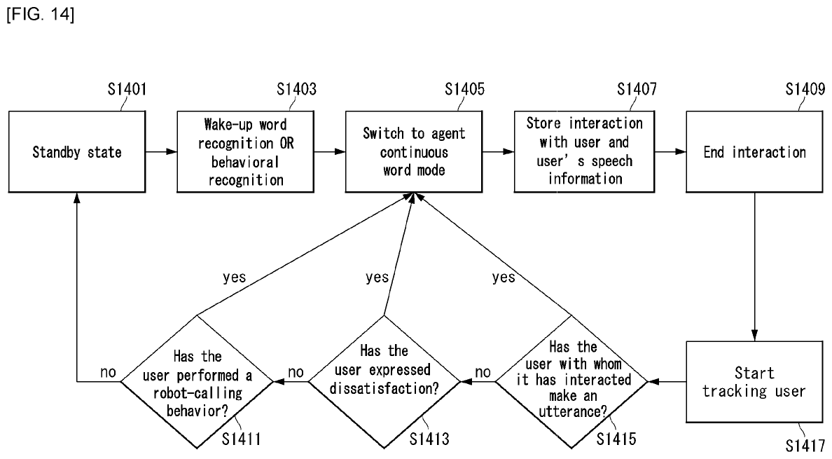

FIG. 14 is a flowchart showing a voice recognizing method according to another exemplary embodiment of the present disclosure.

As shown in FIG. 14, the voice recognizing apparatus 10 may be on standby state (S1401).

Subsequently, the voice recognizing apparatus may recognize a wake-up word or perform behavioral recognition (S1403).

Subsequently, the voice recognizing apparatus may switch to agent continuous word mode (S1405).

Next, the voice recognizing apparatus may store an interaction with a user and the user's speech(voice) information (S1407).

Subsequently, the voice recognizing apparatus may end the interaction (S1409).

Next, the voice recognizing apparatus may start tracking the user (S1417).

Subsequently, the voice recognizing apparatus may determine whether the user with whom it has interacted makes an utterance or not (S1415).

If the user with whom it has interacted makes an utterance, the voice recognizing apparatus may switch to the agent continuous word mode.

If the user with whom it has interacted does not make an utterance, the voice recognizing apparatus may determine whether the user has expressed dissatisfaction or not (S1413).

If it is determined that the user has expressed dissatisfaction, the voice recognizing apparatus may switch to the agent continuous word mode.

If it is determined that the user has not expressed dissatisfaction, the voice recognizing apparatus may determine whether the user has performed a robot-calling behavior or not (S1411).

If it is determined that the user has performed a robot-calling behavior, the voice recognizing apparatus may switch to the agent continuous word mode.

If it is determined that the user has not performed a robot-calling behavior, the voice recognizing apparatus may go back to standby state.

Embodiment 1: A method for a voice recognizing apparatus to intelligently recognize voice, the method comprising: obtaining a first microphone detection signal in wake-up recognition mode; switching to continuous word recognition mode upon recognizing a wake-up word from the first microphone detection signal; obtaining a second microphone detection signal; and performing a function corresponding to a continuous word upon recognizing the continuous word from the second microphone detection signal, wherein the switching to the continuous word recognition mode comprises switching to the continuous word recognition mode upon detecting a preset first gesture.

Embodiment 2: In Embodiment 1, the method further comprises: switching to the wake-up word recognition mode after performing a function corresponding to the continuous word; and switching to the continuous word recognition mode upon recognizing a speaker's utterance of the continuous word after switching to the wake-up word recognition mode.

Embodiment 3: In Embodiment 1, the first gesture comprises a user's gesture of gazing at the voice recognizing apparatus for a preset amount of time,

Embodiment 4: In Embodiment 1, the first gesture comprises a user's gesture of waving a hand toward the voice recognizing apparatus.

Embodiment 5: In Embodiment 1, the method further comprises: switching to the wake-up word recognition mode after performing a function corresponding to the continuous word; and switching to the continuous word recognition mode upon detecting a preset second gesture after switching to the wake-up word recognition mode.

Embodiment 6: In Embodiment 5, the second gesture comprises a user's gesture of giving a particular expression.

Embodiment 7: In Embodiment 6, the second gesture comprises the first gesture.

Embodiment 8: In Embodiment 7, the second gesture comprises the user's gesture of gazing at the voice recognizing apparatus for a preset amount of time.

Embodiment 9: In Embodiment 8, the second gesture comprises the user's gesture of invoking the voice recognizing apparatus.

Embodiment 10: In Embodiment 2 or 5, the continuous word recognition mode is maintained while the user is located within a preset distance from the voice recognizing apparatus.

Embodiment 11: An intelligent voice recognizing apparatus comprising: at least one microphone; a camera; and a processor, wherein the processor obtains a first microphone detection signal in wake-up recognition mode, switches to continuous word recognition mode upon recognizing a wake-up word from the first microphone detection signal, obtains a second microphone detection signal, and performs a function corresponding to a continuous word upon recognizing the continuous word from the second microphone detection signal, wherein the processor switches to the continuous word recognition mode upon detecting a preset first gesture.

Embodiment 12: In Embodiment 11, the processor switches to the wake-up word recognition mode after performing a function corresponding to the continuous word, and switches to the continuous word recognition mode upon recognizing a speaker's utterance of the continuous word after switching to the wake-up word recognition mode.

Embodiment 13: In Embodiment 11, the first gesture comprises a user's gesture of gazing at the voice recognizing apparatus for a preset amount of time,

Embodiment 14: In Embodiment 11, the first gesture comprises a user's gesture of waving a hand toward the voice recognizing apparatus.

Embodiment 15: In Embodiment 11, the processor switches to the wake-up word recognition mode after performing a function corresponding to the continuous word, and switches to the continuous word recognition mode upon detecting a preset second gesture after switching to the wake-up word recognition mode.

Embodiment 16: In Embodiment 15, the second gesture comprises a user's gesture of giving a particular expression.

Embodiment 17: In Embodiment 16, the second gesture comprises the first gesture.

Embodiment 18: In Embodiment 17, the second gesture comprises the user's gesture of gazing at the voice recognizing apparatus for a preset amount of time.

Embodiment 19: In Embodiment 18, the second gesture comprises the user's gesture of invoking the voice recognizing apparatus.

Embodiment 20: In Embodiment 12 or 15, the continuous word recognition mode is maintained while the user is located within a preset distance from the voice recognizing apparatus.

Embodiment 21: A non-transitory, computer-readable recording medium storing a computer-executable component configured to be executed by one or more processors of a computing device, wherein the computer-executable component obtains a first microphone detection signal in wake-up recognition mode, switches to continuous word recognition mode upon recognizing a wake-up word from the first microphone detection signal, obtains a second microphone detection signal, and performs a function corresponding to a continuous word upon recognizing the continuous word from the second microphone detection signal, wherein the computer-executable component switches to the continuous word recognition mode upon detecting a preset first gesture.

The present disclosure described above may be implemented in computer-readable codes in a computer readable recording medium, and the computer readable recording medium may include all kinds of recording devices for storing data that is readable by a computer system. Examples of the computer readable recording medium include HDD (Hard Disk Drive), SSD (Solid State Disk), SDD (Silicon Disk Drive), ROM, RAM, CD-ROM, magnetic tape, floppy disk, optical data storage device, and the like, and may be implemented in the form of carrier waves (e.g., transmission through the internet). Accordingly, the foregoing detailed description should not be interpreted as restrictive in all aspects, and should be considered as illustrative. The scope of the present disclosure should be determined by rational interpretation of the appended claims, and all changes within the equivalent scope of the present disclosure are included in the scope of the present disclosure.

1. A method for a voice recognizing apparatus to intelligently recognize voice, the method comprising:
obtaining a first microphone detection signal in wake-up recognition mode;
switching to continuous word recognition mode upon recognizing a wake-up word from the first microphone detection signal;
obtaining a second microphone detection signal; and
performing a function corresponding to a continuous word upon recognizing the continuous word from the second microphone detection signal,
wherein the switching to the continuous word recognition mode comprises switching to the continuous word recognition mode upon detecting a preset first gesture.

2. The method of claim 1, further comprising:
switching to the wake-up word recognition mode after performing a function corresponding to the continuous word; and
switching to the continuous word recognition mode upon recognizing a speaker's utterance of the continuous word after switching to the wake-up word recognition mode.

3. The method of claim 1, wherein the first gesture comprises a user's gesture of gazing at the voice recognizing apparatus for a preset amount of time,

4. The method of claim 1, wherein the first gesture comprises a user's gesture of waving a hand toward the voice recognizing apparatus.

5. The method of claim 1, further comprising:
switching to the wake-up word recognition mode after performing a function corresponding to the continuous word; and
switching to the continuous word recognition mode upon detecting a preset second gesture after switching to the wake-up word recognition mode.

6. The method of claim 5, wherein the second gesture comprises a user's gesture of giving a particular expression.

7. The method of claim 6, wherein the second gesture comprises the first gesture.

8. The method of claim 7, wherein the second gesture comprises the user's gesture of gazing at the voice recognizing apparatus for a preset amount of time.

9. The method of claim 8, wherein the second gesture comprises the user's gesture of invoking the voice recognizing apparatus.

10. The method of claim 2, wherein the continuous word recognition mode is maintained while the user is located within a preset distance from the voice recognizing apparatus.

11. An intelligent voice recognizing apparatus comprising:
at least one microphone;
a camera; and
a processor,
wherein the processor obtains a first microphone detection signal in wake-up recognition mode, switches to continuous word recognition mode upon recognizing a wake-up word from the first microphone detection signal, obtains a second microphone detection signal, and performs a function corresponding to a continuous word upon recognizing the continuous word from the second microphone detection signal,
wherein the processor switches to the continuous word recognition mode upon detecting a preset first gesture.

12. The voice recognizing apparatus of claim 11, wherein the processor switches to the wake-up word recognition mode after performing a function corresponding to the continuous word, and switches to the continuous word recognition mode upon recognizing a speaker's utterance of the continuous word after switching to the wake-up word recognition mode.

13. The voice recognizing apparatus of claim 11, wherein the first gesture comprises a user's gesture of gazing at the voice recognizing apparatus for a preset amount of time,

14. The voice recognizing apparatus of claim 11, wherein the first gesture comprises a user's gesture of waving a hand toward the voice recognizing apparatus.

15. The voice recognizing apparatus of claim 11, wherein the processor switches to the wake-up word recognition mode after performing a function corresponding to the continuous word, and switches to the continuous word recognition mode upon detecting a preset second gesture after switching to the wake-up word recognition mode.

16. The voice recognizing apparatus of claim 15, wherein the second gesture comprises a user's gesture of giving a particular expression.

17. The voice recognizing apparatus of claim 16, wherein the second gesture comprises the first gesture.

18. The voice recognizing apparatus of claim 17, wherein the second gesture comprises the user's gesture of gazing at the voice recognizing apparatus for a preset amount of time.

19. The voice recognizing apparatus of claim 18, wherein the second gesture comprises the user's gesture of invoking the voice recognizing apparatus.

20. The voice recognizing apparatus of claim 12, wherein the continuous word recognition mode is maintained while the user is located within a preset distance from the voice recognizing apparatus.
